(19) United States
(12) Patent Application Publication
(10) Pub. No.: US 2001/0022994 A1
(43) Pub. Date: Sep. 20, 2001

(54) Plural layer coating film-forming method

(76) Inventors: Kazutoshi Sugiura, Yokohama-shi (JP); Akira Kasari, Hiratsuka-shi (JP); Hiromi Harakawa, Hiratsuka-shi (JP)

Correspondence Address: WENDEROTH, LIND & PONACK, L.L.P., 2033 K STREET N. W., SUITE 800, WASHINGTON, DC, 20006-1021, US

(21) Appl. No.: 09/804,230

(22) Filed: Mar. 13, 2001

(30) Foreign Application Priority Data
Mar. 13, 2000 (JP) 2000-68216

(51) Int. Cl. B05D 1/36; B05D 3/02

(52) U.S. Cl. 427/385.5

(57) ABSTRACT

The present invention provides a method for forming a plural layer coating film which is particularly suited to top coating for an outside plate part of a car, wherein a first water based coating material is applied onto an article to be coated, and a gel content of a coating film formed is controlled to 5% by weight or more; then, a second water based coating material is applied, and moisture contained in a coating film formed is volatilized; then, a clear coating material is applied, and the resulting three layer coating films are heated to cure at the same time.

The present invention relates to a method for forming a plural layer coating film which is particularly useful as top coating for an outside plate part of a car, in which a first water based coating material, a second water based coating material and a clear coating material are applied in order on an article to be coated.

Well known as a method for forming a plural layer coating film using a first water based coating material, a second water based coating material and a clear coating material is a 3 coat 1 bake method (3C1B) in which these coating materials are applied in order one after another and then heated to cure at the same time. This 3C1B has only one step for heating a coating film and therefore is preferred from an energy saving point of view but has the defect that surface roughness on the coated face is insufficiently covered (base covering property).

A principal object of the present invention is to solve the preceding defect in 3C1B and provide a method for forming a plural layer coating film which is excellent in a base covering property.

Intensive researches repeated by the present inventors have resulted in finding that the object described above can be achieved by controlling a gel content of a coating film of a first water based coating material to 5% by weight or more, applying a second water based coating material and volatilizing moisture, then applying a clear coating material and subsequently heating the three layer coating films thus obtained to cure them at the same time, and they have completed the present invention.

Thus, the present invention provides a plural layer coating film-forming method (hereinafter referred to as “the present method”) characterized by applying a first water based coating material onto the article to be coated, controlling a gel content of a coating film formed to 5% by weight or more, applying a second water based coating material and volatilizing moisture contained in the coating film formed, then applying a clear coating material and subsequently heating the resulting three layer coating films to cure them at the same time.

In the present method, the first water based coating material, the second water based coating material and the clear coating material are used to form plural layer coating films by 3C1B, and it has novel characteristics particularly in (1) the point that a gel content of a coating film of the first water based coating material is controlled to 5% by weight or more and then the second water based coating material is applied and (2) the point that moisture contained in a coating film of the second water based coating material is at least partially volatilized and then the clear coating material is applied.

Controlling a gel content of the coating film of the first water based coating material to such a range makes it possible to cover fine irregularities which are present, if any, on the coated surface thereof to finish it to the smooth coated surface. The gel content can readily be controlled by controlling drying conditions (temperature, time and the like) in drying the coating film at a lower temperature than a curing temperature thereof, usually 100° C. or lower. A gel content of a coating film can be determined by isolating a dried coating film, extracting the isolated coating film in acetone for 3 hours and then calculating a residual rate (% by weight) of the coating film. In the present invention, a gel content of the coating film of the first water based coating material in applying the second water based coating material has to fall in a range of 5% by weight or more, preferably 40% by weight or more, particularly preferably 50% by weight or more and further more preferably 55 to 98% by weight. If a gel content of the coating film of the first water based coating material in applying the second water based coating material is smaller than 5% by weight, the resulting coating film is inferior in a base covering property, and therefore it is not preferred.

Further, moisture contained in the coating film of the second water based coating material is volatilized according to the present invention, and then the clear coating material is applied, whereby obtained are the effects that popping, rough surface and mottling of the coating film can be prevented from being caused and that the coating film of the clear coating material can be improved in distinctness-of-image gloss. The moisture can be volatilized by drying the coating film at a lower temperature than a curing temperature thereof, usually 100° C. or lower. A moisture content in the coating film of the second water based coating material after volatilizing the moisture is preferably 15% by weight or less, particularly 10% by weight or less and further particularly 5% by weight or less. The moisture content in the coating film is a value determined by applying the second water based coating material on a tin plate on prescribed conditions and drying it, then sampling about one g of the coating film thereof, mixing it in 100 g of anhydrous tetrahydrofuran to prepare a sample and measuring a moisture amount contained in this sample by means of a “Hiranuma trace amount moisture-measuring meter modelAQ-6” of a Karl Fischer amperometric titration system manufactured by Hiranuma Sangyo Co., Ltd. to convert it to a moisture content (% by weight) in 1 g of the coating film.

The first water based coating material used in the present invention is a coating material comprising water as a principal solvent or dispersant, and a conventionally known water based coating material can be used therefor. To be specific, a coating material comprising a base resin, a cross-linking agent, a color pigment and water can be used. The base resin includes, for example, acryl resins and polyester resins each having a cross-linking functional group such as a hydroxyl group and, if necessary, a hydrophilic group such as a carboxyl group. The cross-linking agent includes, for example, hydrophilic or hydrophobic melamine resins. Further, solid color pigments, metallic pigments and photo-interferential pigments for conventional coating materials can be used as the color pigment.

In particular, a gel content of a water based coating material (i) comprising a hydroxyl group-containing resin (a), a melamine resin (b), a ketone group-containing resin (c) and a compound (d) having a hydrazide group or a semicarbazide group or a water based coating material (ii) comprising a resin (e) containing a hydroxyl group and a ketone group, a melamine resin (b) and a compound (d) having a hydrazide group or a semicarbazide group can readily be controlled to the range described above by drying a coating film thereof at a temperature of 100° C. or lower, and therefore it is suited as the first water based coating material.

Capable of being used as the hydroxyl group-containing resin (a) are resins such as conventionally known acryl resins, vinyl resins and polyester resins each containing at least two hydroxyl groups and, if necessary, a carboxyl group in a molecule. These resins have preferably a hydroxyl group value falling in a range of usually 5 to 200, particularly 20 to 150, an acid value falling in a range of usually 5 to 100, particularly 10 to 70 and a number average molecular weight falling in a range of usually about 3000 to about 100000, particularly about 5000 to about 50000. The above resins can be made water-soluble or water-dispersible by neutralizing carboxyl groups contained, if necessary, in these resins with a basic compound. These resins can be produced by conventional emulsion polymerization or solution polymerization.

The melamine resin (b) can be used as a cross-linking agent for the hydroxyl group-containing resin (a) described above and includes, to be specific, methylol-reduced melamine resins obtained by reacting melamine with formaldehyde and partially or fully etherified melamine resins obtained by further reacting the above melamine resins with monoalcohol having 1 to 10, particularly 1 to 4 carbon atoms. An imino group may be present in combination in these melamine resins. These melamine resins (b) may be either hydrophobic or hydrophilic. In particular, the hydrophilic melamine resins having a number average molecular weight falling in a range of usually 3000 or less, particularly 100 to 1500 are suited.

The ketone group-containing resin (c) is a compound having at least one ketone group (═C═O) in a molecule and can be obtained by (co)polymerizing only a ketone group-containing polymerizable monomer or other polymerizable monomers therewith.

The ketone group-containing polymerizable monomer is a compound having each at least one ketone group and polymerizable double bond in a molecule and includes, for example, diacetoneacrylamide, diacetonemethacrylamide, acrolein, vinyl methyl ketone, vinyl ethyl ketone, vinyl butyl ketone, diacetoneacrylate, acetonitrileacrylate and formylstyrol.

The other polymerizable monomer which is copolymerizable with the ketone group-containing polymerizable monomer is a compound having at least one polymerizable double bond in a molecule and includes, for example, alkyl (having 1 to 20 carbon atoms) esters of acrylic acid or methacrylic acid such as methyl (meth)acrylate, ethyl (meth)acrylate, propyl (meth)acrylate, butyl (meth)acrylate, hexyl (meth)acrylate, cyclohexyl (meth)acrylate, 2-ethylhexyl (meth)acrylate, lauryl (meth)acrylate and stearyl (meth)acrylate; alkoxyalkyl (having 2 to 20 carbon atoms) esters of acrylic acid or methacrylic acid such as methoxybutyl (meth)acrylate, methoxyethyl (meth)acrylate and ethoxybutyl (meth)acrylate; hydroxyalkyl (having 2 to 8 carbon atoms) esters of acrylic acid or methacrylic acid such as 2-hydroxyethyl (meth)acrylate, hydoxypropyl (meth)acrylate and hydoxybutyl (meth)acrylate; carboxyl group-containing unsaturated compounds such as acrylic acid, methacrylic acid, crotonic acid, itaconic acid, maleic acid and fumaric acid; glycidyl group-containing unsaturated compounds such as glycidyl (meth)acrylate; and other monomers such as acrylonitrile, styrene, vinyl chloride, vinyl acetate and acrylamide.

These polymerizable monomers can be (co)polymerized by a conventionally known method, and a use percentage of the ketone group-containing polymerizable monomer to the other polymerizable monomer in (co)polymerizing falls in a range of usually 0.1 to 100%, particularly 1 to 30% based on the total weight of both monomers in the case of the ketone group-containing polymerizable monomer and usually 99.9 to 0%, particularly 99 to 70% in the case of the other polymerizable monomer. The ketone group-containing resin (c) thus obtained has preferably a number average molecular weight falling in a range of usually about 2000 to about 50000, particularly about 3000 to about 20000. Further, the ketone group-containing resin (c) has preferably a carbonyl value falling in a range of usually 0.01 to 3 mmol/g/solid matte, particularly 0.05 to 2 mmol/g/solid matte.

The compound (d) having a hydrazide group or a semicarbazide group is a compound having at least 2, preferably 2 to 10 hydrazide groups represented by —CO—NH—NH₂ or a semicarbazide group represented by —NH—CO—NH—NH₂ and includes, for example, saturated aliphatic carboxylic dihydrazides having 2 to 18 carbon atoms such as compounds represented by H₂N—NH—CO—(CH₂)ₙ—CONH—NH₂ (in the formula, n is 0 to 8, particularly 1 to 6), oxalic dihydrazide, malonic dihydrazide, glutaric dihydrazide, succinic dihydrazide, adipic dihydrazide and sebacic dihydrazide; monoolefinic unsaturated dicarboxylic dihydrazides such as maleic dihydrazide, fumaric dihydrazide and itaconic dihydrazide; dihydrazides of aromatic dicarboxylic acids such as phthalic acid, terephthalic acid and isophthalic acid; dihydrazides, trihydrazides and tetrahydrazides of pyromellitic acid; nitrilotrihydrazide, citric trihydrazide, 1,2,4-benzenetrihydrazide, ethylenediaminetetraacetic tetrahydrazide, 1,4,5,8-naphthoic tetrahydrazide and polyhydrazides obtained by reacting hydrazine or hydrazine hydrates with lower polymers having a carboxylic acid lower alkyl ester group (refer to Japanese Patent Publication No. 22878/1977); carbonic dihydrazide and bissemicarbazide; multifunctional semicarbazides obtained by reacting diisocyanates such as hexamethylene-diisocyanate and isophoronediisocyanate or diisocyanate compounds derived from them with N,N-substituted hydrazines such as N,N-dimethylhydrazine and the hydrazides described above in excess, aqueous multifunctional semicarbazides obtained by reacting isocyanate groups contained in reaction products of the above polyisocyanate compounds with active hydrogen compounds containing hydrophilic groups such as polyetherpolyols and polyethylene glycol monoalkyl ethers with the hydrazides described above in excess, or mixtures of the above multifunctional semicarbazides and the aqueous multifunctional semicarbazides (refer to Japanese Patent Application Laid-Open No. 151358/1996, Japanese Patent Application Laid-Open No. 283377/1996 and Japanese Patent Application Laid-Open No. 245878/1996). Among them, particularly suited are the multifunctional semicarbazides and the aqueous multifunctional semicarbazides.

The blending percentages of the hydroxyl group-containing resin (a), the melamine resin (b), the ketone group-containing resin (c) and the compound (d) having a hydrazide group or a semicarbazide group in the water based coating material (i) shall not strictly be restricted and can be changed in a wide range according to use purposes of the coated products. In the cases of, for example, the resin (a) and the resin), a percentage of the resin (a) falls suitably in a range of usually 50 to 90% by weight, particularly 60 to 80% by weight based on the total solid matter weight of these both resins; and a percentage of the resin (b) falls suitably in a range of usually 50 to 10% by weight, particularly 40 to 20% by weight. A ratio of the ketone group-containing resin (c) to the compound (d) having a hydrazide group or a semicarbazide group is suitably such a ratio that a hydrazide group or a semicarbazide group contained in the compound (d) falls in a range of usually 0.1 to 2 equivalent, particularly 0.2 to 1.2 equivalent per equivalent of a ketone group contained in the resin (c). The components (a) to (d) are preferably blended in such a proportion that the total solid matter of the ketone group-containing resin (c) and the compound (d) falls in a range of usually 50 to 300 parts by weight, particularly 100 to 200 parts by weight per 100 parts by weight of the total solid matter of the resin (a) and the resin (b).

In the present invention, the water based coating material (ii) comprising the resin (e) containing a hydroxyl group and a ketone group, the melamine resin (b) and the compound (d) having a hydrazide group or a semicarbazide group can similarly be used as the first water based coating material in place of the water based coating material (i).

Among them, those described above for the water based coating material (i) can suitably be used as the melamine resin (b) and the compound (d) having a hydrazide group or a semicarbazide group.

The resin (e) containing a hydroxyl group and a ketone group has each at least one hydroxyl group and ketone group in a molecule, and this can be obtained by copolymerizing, for example, a hydroxyl group-containing polymerizable monomer and a ketone group-containing polymerizable monomer and, if necessary, other polymerizable monomers.

The hydroxyl group-containing polymerizable monomer is a compound having each at least one hydroxyl group and polymerizable double bond, and capable of being used are, for example, hydroxyalkyl (having 2 to 8 carbon atoms) esters of acrylic acid or methacrylic acid such as 2-hydroxyethyl (meth)acrylate, hydoxypropyl (meth)acrylate and hydoxybutyl (meth)acrylate.

Also, the ketone group-containing polymerizable monomer is a compound having each at least one ketone group and polymerizable double bond in a molecule and includes, for example, diacetoneacrylamide, diacetone-methacrylamide, acrolein, vinyl methyl ketone, vinyl ethyl ketone, vinyl butyl ketone, diacetoneacrylate, acetonitrileacrylate and formylstyrol.

The other polymerizable monomer is a compound having at least one polymerizable double bond which is copolymerizable with the preceding hydroxyl group-containing polymerizable monomers and ketone group-containing polymerizable monomers in a molecule, and the “other polymerizable monomers” given as the examples in the ketone group-containing resin (c) described above can similarly be given as the examples thereof.

The use percentages of the hydroxyl group-containing polymerizable monomer, the ketone group-containing polymerizable monomer and the other polymerizable monomer in producing the resin (e) containing a hydroxyl group and a ketone group shall not strictly be restricted and can be changed in a wide range according physical properties desired to the coating film formed. It falls suitably in a range of, for example, usually 1 to 50% by weight, particularly 5 to 30% by weight based on the total weight of these monomers in the case of the hydroxyl group-containing polymerizable monomer; it falls suitably in a range of usually 1 to 30% by weight, particularly 5 to 20% by weight in the case of the ketone group-containing polymerizable monomer; and it falls suitably in a range of usually 98 to 20% by weight, particularly 90 to 50% by weight in the case of the other polymerizable monomer. These monomers can be copolymerized by conventionally known methods. The resin (e) thus obtained containing a hydroxyl group and a ketone group has preferably a number average molecular weight falling in a range of usually about 3000 to about 100000, particularly about 5000 to about 50000. Further, the above resin (e) has preferably a hydroxyl group value falling in a range of usually 5 to 200, particularly 20 to 150 and a carbonyl value falling in a range of usually 0.01 to 3 mmol/g/solid matte, particularly 0.05 to 2 mmol/g/solid matte.

The blending percentages of the resin (e) containing a hydroxyl group and a ketone group, the melamine resin (b) and the compound (d) having a hydrazide group or a semicarbazide group in the water based coating material (ii) shall not strictly be restricted and can be changed in a wide range according to use purposes of the coated products. It falls preferably in a range of usually 50 to 90% by weight, particularly 60 to 85% by weight based on the total solid matter weight of the resin (e) containing a hydroxyl group and a ketone group and the melamine resin (b) in the case of the resin (e); and it falls preferably in a range of usually 50 to 10% by weight, particularly 40 to 15% by weight in the case of the resin (b). Further, the compound (d) is contained preferably in such a proportion that a hydrazide group or a semicarbazide group falls in a range of 0.1 to 2 equivalent, particularly 0.2 to 1.2 equivalent per equivalent of a ketone group contained in the resin (e).

The water based coating material (i) and the water based coating material (ii) can be blended with a color pigment such as a solid color pigment, a metallic pigment and a photo-interferential pigment for conventional coating materials and, if necessary, a settling preventive and an organic solvent in addition to the components described above.

The first water based coating material used in the method of the present invention is obtained by mixing, dissolving and dispersing the respective components described above in an aqueous medium. A coating film formed from this first water based coating material shows a solid color tone, a metallic tone and a photo-interferential tone and is excellent in a covering property, and it is preferably colored to such an extent that a color tone of the coated surface can not visually be observed through this coating film.

The first water based coating material can be applied directly on metal-made or plastic-made articles to be coated. In general, however, these articles to be coated are coated in advance with an undercoating material such as an electrodepositably coating material and, if necessary, an intermediate coating material, and these coating films are cured, followed by suitably applying the first water based coating material.

The first water based coating material is controlled to a viscosity falling in a range of usually 30 to 70 seconds/Ford cup #4/20° C., preferably 40 to 60 seconds/Ford cup #4/20° C. and preferably coated by airless spraying, air spraying and electrostatic coating. A film thickness thereof falls suitably in a range of 5 to 50 μm, particularly 10 to 45 μm in terms of a cured film thickness.

In the present invention, a gel content of the coating film thus coated comprising the first water based coating material has to be controlled to at least 5% by weight, preferably at least 40% by weight and more preferably at least 50% by weight. The coating film having such gel content can easily be obtained by leaving standing, for example, at a temperature of 100° C. or lower for 1 to 20 minutes.

In the present invention, the first water based coating material is applied to control a gel content of the coating film thereof to the range described above, and then the second water based coating material is applied on the coated surface thereof.

The second water based coating material is a coating material comprising water as a principal solvent or dispersant as is the case with the first water based coating material, and a conventionally known water based coating material can be used therefor. To be specific, a thermosetting coating material comprising a base resin, a cross-linking agent and water can be used. The base resin includes, for example, acryl resins and polyester resins each having a cross-linking functional group such as a hydroxyl group and, if necessary, a hydrophilic group such as a carboxyl group. The cross-linking agent includes, for example, hydrophilic or hydrophobic melamine resins. Further, the second water based coating material can contain as well a color pigment such as a solid color pigment, a metallic pigment and a photo-interferential pigment for conventional coating materials, a settling preventive and an organic solvent. The second water based coating material may form any of colored opaque, colored transparent and colorless transparent coating films. The colored coating film formed from the second water based coating material can show a solid color tone, a metallic tone and a photo-interferential tone.

The second water based coating material is controlled to a viscosity falling in a range of usually 30 to 70 seconds/Ford cup #4/20° C., preferably 40 to 60 seconds/Ford cup #4/20° C. and preferably coated by air spraying, airless spraying and electrostatic coating. A film thickness thereof falls suitably in a range of 5 to 25 μm, particularly 10 to 20 μm in terms of a cured film thickness.

According to the present invention, moisture contained in the coating film thus coated comprising the second water based coating material is volatilized. To be specific, for example, the second water based coating material is applied and then left standing at a temperature of 100° C. or lower for 1 to 20 minutes, whereby moisture contained in the coating film is volatilized. The moisture contained in the coating film of the second water based coating material is preferably volatilized to such an extent that a moisture content in the coating film becomes 15% by weight or less, particularly 10% by weight or less and more particularly 5% by weight or less.

In the method of the present invention, the first water based coating material and the second water based coating material are applied in the manner described above, and moisture contained in the coating film of the second water based coating material is volatilized. Then, a clear coating material is applied on the coated face of the second water based coating material.

The clear coating material is a coating material for forming a colorless transparent or colored transparent coating film, and conventionally known organic solvent base coating materials or water based coating materials can be used therefor. To be specific, a thermosetting coating material comprising a base resin, a cross-linking agent and a solvent (water and/or an organic solvent) can be used. The base resin includes, for example, acryl resins and polyester resins each having a cross-linking functional group such as a hydroxyl group and, if necessary, a hydrophilic group such as a carboxyl group. The cross-linking agent includes, for example, hydrophilic or hydrophobic melamine resins. Further, the clear based coating material can contain a color pigment such as a solid color pigment, a metallic pigment and a photo-interferential pigment for conventional coating materials to such an extent that the transparency is not damaged.

The clear coating material is controlled to a viscosity falling in a range of usually 20 to 40 seconds/Ford cup #4/20° C., preferably 25 to 35 seconds/Ford cup #4/20° C. and preferably coated by air spraying, airless spraying and electrostatic coating. A film thickness thereof falls suitably in a range of 25 to 50 μm, particularly 30 to 45 μm in terms of a cured film thickness.

Three layer coating films formed in the manner described above comprising the first water based coating material, the second water based coating material and the clear coating material are then heated at a temperature of, for example, about 100 to about 180° C., preferably about 120 to about 160° C. for not much longer than 10 to 40 minutes to bake these three layer coating films and cure them at the same time, whereby the plural layer coating film according to the present invention can be formed.

According to the method of the present invention described above, the first water based coating material, the second water based coating material and the clear coating material are applied by 3C1B, and therefore simplification of a heating step for a coating film is achieved and effective for energy saving. The coating film formed by the method of the present invention has a good base covering property, and even the coated surface which is rough and has fine irregularities can be finished to a coated surface which is excellent in smoothness. Further, the water based coating material (i) and the water based coating material (ii) each having the specific composition described above are used as the first water based coating material whereby the effects described above can more notably be exhibited.

The present invention shall be explained below in further details with reference to examples and comparative examples. Parts and percentage are based on weight, and a film thickness of the coating film is shown in terms of a cured film thickness.

1. Preparation of first water based coating material (the blending amounts are solid matter amounts)

(a): Mixed were 25 parts of a polymer (A) (remark 1), 60 parts of a polymer (B) (remark 2), 15 parts of “Cymel 327” (trade name, a melamine resin manufactured by Cytec Industries Co., Ltd.) and 7.8 parts of “SX-801” (trade name, a semicarbazide group-containing compound solution manufactured by Asahi Chemical Industry Co., Ltd.; solid matter content: 45%, and a mixed solvent of water and propylene glycol monopropyl ether was used as a solvent), and water was added to adjust the viscosity to 40 seconds/Ford cup #4/20° C. Semicarbazide group concentration: 4.6 mmol/g/solid matter.

(Remark 1) polymer (A): prepared by neutralizing with dimethylethanolamine, a polymer (hydroxyl group value: 72, acid value: 39, number average molecular weight: 12000) obtained by copolymerizing 15 parts of styrene, 20 parts of methyl methacrylate, 25 parts of ethyl acrylate, 20 parts of n-butyl acrylate, 15 parts of hydroxyethyl acrylate and 5 parts of acrylic acid.

(Remark 2) polymer (B): prepared by neutralizing with dimethylethanolamine, a polymer (hydroxyl group value: 0, acid value: 39, carbonyl value: 0.6 mmol/g/solid matter, number average molecular weight: 12000) obtained by copolymerizing 15 parts of styrene, 20 parts of methyl methacrylate, 25 parts of ethyl acrylate, 25 parts of n-butyl acrylate, 5 parts of acrylic acid and 10 parts of diacetoneacrylamide.

(b): Mixed were 80 parts of a polymer (C) (remark 3), 20 parts of “Cymel 327” and 5.2 parts of “SX-801”, and water was added to adjust the viscosity to 40 seconds/Ford cup #4/20° C. Semicarbazide group concentration: 4.6 mmol/g/solid matter.

(Remark 3) polymer (C): prepared by neutralizing with dimethylethanolamine, a polymer (hydroxyl group value: 72, acid value: 39, carbonyl value: 0.3 mmol/g/solid matter, number average molecular weight: 12000) obtained by copolymerizing 15 parts of styrene, 20 parts of methyl methacrylate, 25 parts of ethyl acrylate, 15 parts of n-butyl acrylate, 15 parts of hydroxyethyl acrylate, 5 parts of acrylic acid and 5 parts of diacetoneacrylamide.

(c): Mixed were 60 parts of the polymer (A) and 37 parts of “Cymel 327”, and water was added to adjust the viscosity to 40 seconds/Ford cup #4/20° C.

2. Examples and comparative examples

### EXAMPLE 1

A first water based coating material (a) was applied in a film thickness of 20 μm on a dull steel plate prepared by applying a cationically electrodepositable coating material (film thickness: 20 μm) and curing the coating film thereof by heating, and it was dried at 80° C. for 10 minutes (gel content of the coating film: 55%). Then, applied on the coated surface thereof in a film thickness of 20 μm was a water based metallic coating material (“TW-700”, trade name, acrylmelamine resin base, water based silver metallic coating material manufactured by Kansai Paint Co., Ltd.) adjusted to a viscosity of 40 seconds/Ford cup #4/20° C., and it was dried at 80° C. for 10 minutes (moisture content in the coating film: 5% or less). Then, further applied in a film thickness of 35 μm was an organic solvent type clear coating material (“TC-75”, trade name, acryl-melamine resin base, organic solvent type clear coating material manufactured by Kansai Paint Co., Ltd.) adjusted to a viscosity of 23 seconds/Ford cup #4/20° C., and it was baked at 140° C. for 30 minutes to cure three layer coating films at the same time. The resulting three layer coating film had a good base covering property, and the irregularity feeling originating in the dull steel plate and the electrodepositable coating film was not observed at all. The smoothness was good, and the metallic feeling and the distinctness-of-image gloss were excellent as well.

### EXAMPLE 2

A first water based coating material (b) was applied in a film thickness of 20 μm on a dull steel plate prepared by applying a cationically electrodepositable coating material (film thickness: 20 μm) and curing the coating film thereof by heating, and it was dried at 80° C. for 10 minutes (gel content of the coating film: 70%). Then, applied on the coated surface thereof in a film thickness of 20 μm was the water based metallic coating material (“TW-700”, trade name, acryl-melamine resin base, water based silver metallic coating material manufactured by Kansai Paint Co., Ltd.) adjusted to a viscosity of 40 seconds/Ford cup #4/20° C., and it was dried at 80° C. for 10 minutes (moisture content in the coating film: 5% or less). Then, further applied in a film thickness of 35 μm was the organic solvent type clear coating material (“TC-75”, trade name, acryl-melamine resin base, organic solvent type clear coating material manufactured by Kansai Paint Co., Ltd.) adjusted to a viscosity of 23 seconds/Ford cup #4/20° C., and it was baked at 140° C. for 30 minutes to cure three layer coating films at the same time. The resulting three layer coating film had a good base covering property, and the irregularity feeling originating in the dull steel plate and the electrodepositable coating film was not observed at all. The smoothness was good, and the metallic feeling and the distinctness-of-image gloss were excellent as well.

### Comparative Example 1

A first water based coating material (c) was applied in a film thickness of 20 μm on a dull steel plate prepared by applying a cationically electrodepositable coating material (film thickness: 20 μm) and curing the coating film thereof by heating, and it was dried at 80° C. for 10 minutes (gel content of the coating film: 0%). Then, applied on the coated surface thereof in a film thickness of 20 μm was the water based metallic coating material (“TW-700”, trade name, acryl-melamine resin base, water based silver metallic coating material manufactured by Kansai Paint Co., Ltd.) adjusted to a viscosity of 40 seconds/Ford cup #4/20° C., and it was dried at 80° C. for 10 minutes (moisture content in the coating film: 5% or less). Then, further applied in a film thickness of 35 μm was the organic solvent type clear coating material (“TC-75”, trade name, acryl-melamine resin base, organic solvent type clear coating material manufactured by Kansai Paint Co., Ltd.) adjusted to a viscosity of 23 seconds/Ford cup #4/20° C., and it was baked at 140° C. for 30 minutes to cure three layer coating films at the same time. The resulting three layer coating film had a poor base covering property, and the irregularity feeling originating in the dull steel plate and the electrodepositable coating film was observed. The smoothness was inferior, and the metallic feeling and the distinctness-of-image gloss were inferior as compared with the examples described above.

1. A plural layer coating film-forming method characterized by applying a first water based coating material onto an article to be coated, controlling a gel content of a coating film formed to 5% by weight or more, applying a second water based coating material and volatilizing moisture contained in a coating film formed, then applying a clear coating material and subsequently heating resulting three layer coating films to cure them at the same time.

2. The plural layer coating film-forming method as described in claim 1, wherein the first water based coating material is a water based coating material (i) comprising a hydroxyl group-containing resin (a), a melamine resin (b), a ketone group-containing resin (c) and a compound (d) having a hydrazide group or a semicarbazide group or a water based coating material (ii) comprising a resin (e) containing a hydroxyl group and a ketone group, a melamine resin (b) and a compound (d) having a hydrazide group or a semicarbazide group.

3. The plural layer coating film-forming method as described in claim 2, wherein the hydroxyl group-containing resin (a) has a hydroxyl group value falling in a range of 5 to 200, an acid value falling in a range of usually 5 to 100 and a number average molecular weight falling in a range of 3000 to 100000.

4. The plural layer coating film-forming method as described in claim 2, wherein the melamine resin (b) is a hydrophilic melamine resin having a number average molecular weight of 3000 or less.

5. The plural layer coating film-forming method as described in claim 2, wherein the ketone group-containing resin (c) has a carbonyl value falling in a range of 0.01 to 3 mmol/g/solid matte and a number average molecular weight falling in a range of 2000 to 50000.

6. The plural layer coating film-forming method as described in claim 2, wherein the compound (d) having a hydrazide group or a semicarbazide group is selected from the group consisting of multifunctional semicarbazide and aqueous multifunctional semicarbazide.

7. The plural layer coating film-forming method as described in claim 2, wherein the resin (a) and the resin (b) are contained in the water based coating material (i) in a proportion of 50 to 90% by weight of the resin (a) and 50 to 10% by weight of the resin (b) based on the total solid matter weight of these both resins.

8. The plural layer coating film-forming method as described in claim 2, wherein the ketone group-containing resin (c) and the compound (d) having a hydrazide group or a semicarbazide group are contained in the water based coating material (i) in such a ratio that a hydrazide group or a semicarbazide group contained in the compound (d) falls in a range of 0.1 to 2 equivalent per equivalent of a ketone group contained in the resin (c).

9. The plural layer coating film-forming method as described in claim 2, wherein the total solid matter of the ketone group-containing resin (c) and the compound (d) in the water based coating material (i) falls in a range of 50 to 300 parts by weight per 100 parts by weight of the total solid matter of the resin (a) and the resin (b).

10. The plural layer coating film-forming method as described in claim 2, wherein the resin (e) containing a hydroxyl group and a ketone group has a hydroxyl group value falling in a range of 5 to 200, a carbonyl value falling in a range of 0.01 to 3 mmol/g/solid matte and a number average molecular weight falling in a range of 3000 to 100000.

11. The plural layer coating film-forming method as described in claim 2, wherein the resin (e) containing a hydroxyl group and a ketone group and the melamine resin (b) are contained in the water based coating material (ii) in a proportion of 50 to 90% by weight of the resin (e) and 50 to 10% by weight of the resin (b) based on the total solid matter weight of these both resins.

12. The plural layer coating film-forming method as described in claim 2, wherein the compound (d) is contained in the water based coating material (ii) in such a proportion that a hydrazide group or a semicarbazide group falls in a range of 0.1 to 2 equivalent per equivalent of a ketone group contained in the resin (e).

13. The plural layer coating film-forming method as described in claim 1, wherein the coating film of the first water based coating material is controlled to a gel content of 5% by weight or more.

14. The plural layer coating film-forming method as described in claim 1, wherein the coating film of the first water based coating material has a film thickness of 5 to 50 μm in terms of a cured film thickness.

15. The plural layer coating film-forming method as described in claim 1, wherein moisture contained in the coating film of the second water based coating material is volatilized until a moisture content in the coating film becomes 15% by weight or less.

16. The plural layer coating film-forming method as described in claim 1, wherein the moisture contained in the coating film of the second water based coating material is volatilized until a moisture content in the coating film becomes 10% by weight or less.

17. The plural layer coating film-forming method as described in claim 1, wherein the coating film of the second water based coating material has a film thickness of 5 to 25 μm in terms of a cured film thickness.

18. The plural layer coating film-forming method as described in claim 1, wherein the coating film of the clear coating material has a film thickness of 25 to 50 μm in terms of a cured film thickness.

19. The plural layer coating film-forming method as described in claim 1, wherein the resulting three layer coating films are heated to a temperature of about 100 to 180° C. and cured at the same time.

20. An article coated by the method as described in claim 1.
